(19) United States
(12) Patent Application Publication
(10) Pub. No.: US 2007/0220877 A1
(43) Pub. Date: Sep. 27, 2007

(54) Integral stator and one-way clutch

(75) Inventors: Philip George, Wooster, OH (US); William Brees, Wooster, OH (US); Steven Olsen, Wooster, OH (US); Charles Nichols, Seville, OH (US); Ross A. Gresley, Tega Cay, SC (US); Swen Doerrie, Herzogenaurach (DE)

Correspondence Address: SIMPSON & SIMPSON, PLLC, 5555 MAIN STREET, WILLIAMSVILLE, NY, 14221-5406, US

(73) Assignee: LuK Lamellen und Kupplungsbau Beteiligungs KG, Buehl (DE)

(21) Appl. No.: 11/726,881

(22) Filed: Mar. 23, 2007

Related U.S. Application Data
(60) Provisional application No. 60/785,693, filed on Mar. 24, 2006.

(51) Int. Cl. F16D 33/00

(52) U.S. Cl. 60/345

(57) ABSTRACT

The present invention broadly comprises a stator and clutch assembly for a torque converter including first and second halves for a stator, each formed from first and second single pieces. Blades for the stator are disposed within respective annuli for the first and second halves. The assembly also includes a one-way clutch. The first and second halves have inner circumferential portions configured to form a portion of the clutch. The assembly includes an axially displaceable plate connected to a hub. The plate and a circumferential portion are operatively arranged to form a portion of the clutch. In some aspects, the plate and the circumferential portion are arranged to lockingly engage and the assembly includes a displacement element arranged to urge the plate toward the circumferential portion. In some aspects, the plate and hub are formed from a single piece or the plate is axially displaceable with respect to the hub.

### CROSS-REFERENCE TO RELATED APPLICATIONS

This application claims the benefit under 35 U.S.C. §119(e) of U.S. Provisional Application No. 60/785,693, filed Mar. 24, 2006.

### FIELD OF THE INVENTION

The invention relates to improvements in apparatus for transmitting force between a rotary driving unit (such as the engine of a motor vehicle) and a rotary driven unit (such as the variable-speed transmission in the motor vehicle). In particular, the invention relates to an assembly for a torque converter combining a stator and one-way clutch. Specifically, the assembly includes parts or components shared by the stator and the clutch.

### BACKGROUND OF THE INVENTION

An axially engaging and disengaging one-way clutch mechanism for a torque converter is shown in commonly assigned U.S. Provisional Patent Application No. 60/710,828, titled “STATOR HAVING AN AXIALLY ENGAGING AND DISENGAGING ONE-WAY CLUTCH MECHANISM FOR A TORQUE CONVERTER,” inventors Brees et al., filed Aug. 24, 2005, which application is incorporated as background information by reference. The arrangement shown in the above application could be improved if parts or components could be shared between the stator and the clutch. Such sharing could reduce the parts count, complexity, and cost for the torque converter.

Thus, there is a long-felt need to combine components for a stator and a one-way clutch in a torque converter to reduce parts count, complexity, and cost for the stator and one-way clutch.

### BRIEF SUMMARY OF THE INVENTION

The present invention broadly comprises a stator and clutch assembly for a torque converter, including a first half for a stator and a second half for the stator. The first and second halves are each formed from first and second single pieces and blades for the stator are disposed within respective annuli for the first and second halves. The assembly also includes a one-way clutch and the first and second halves have first and second inner circumferential portions, respectively, configured to form a portion of the one-way clutch. The assembly includes an axially displaceable plate connected to a hub. The plate and the first inner circumferential portion are operatively arranged to form a portion of the one-way clutch. In some aspects, the plate and the first inner circumferential portion are arranged to lockingly engage.

In some aspects, the first inner circumferential portion includes at least one first opening and the plate further includes at least one first protrusion axially aligned with the at least one first opening. In some aspects, the plate includes at least one second opening and the first inner circumferential portion includes at least one second protrusion axially aligned with the at least one second opening.

In some aspects, the assembly includes a displacement element arranged to urge the plate axially toward the first inner circumferential portion. In some aspects, the plate and the hub are formed from a third single piece and the displacement element is disposed between the second inner circumferential portion and the plate. In some aspects, the plate is axially displaceable with respect to the hub and the displacement element is disposed between the plate and the hub.

In some aspects, the assembly includes a wear-prevention element disposed between the hub and a first element selected from the group consisting of the first and second inner circumferential portions. In some aspects, the first half includes a first annular portion disposed between the clutch and the annulus for the first half, the second half includes a second annular portion disposed between the clutch and the annulus for the second half, and at least portions of the first and second annular portions are in contact. Then, the torque converter includes first and second bearing and the first and second annular portions are operatively arranged to receive the first and second bearings, respectively. In some aspects, the first and second halves include at least one first and second retention elements, respectively, operatively arranged to engage the first and second bearings, respectively.

The present invention also broadly comprises a stator and clutch assembly for a torque converter including a first axial portion for a stator, a second axial portion for the stator, and a one-way clutch. The first axial portion includes a first annular portion disposed radially outside the clutch, the second axial portion includes a second annular portion disposed radially outside the clutch, at least portions of the first and second annular portions are in contact, and the first and second annular portions are operatively arranged to receive first and second bearings, respectively.

The present invention further broadly comprises a stator and clutch assembly for a torque converter, including a first axial end for a stator comprising a first circumferential portion disposed between blades for the stator and an axis for the stator, a second axial end for the stator comprising a second circumferential portion disposed between the blades and the axis, and a one-way clutch with an axially displaceable plate. The first and second ends are each formed from first and second single pieces, respectively, the plate and the first circumferential portion are operatively arranged to form a portion of the one-way clutch, and the plate and the first circumferential portion are arranged to lockingly engage.

It is a general object of the present invention to provide a stator formed from two axial segments or halves.

It is another object of the present invention to reduce the parts count and complexity for a stator and one-way clutch in a torque converter.

It is yet another object of the present invention to provide a more easily assembled stator and one-way clutch for a torque converter.

It is a further object of the present invention to provide a stator and one-way clutch made using more cost-effective fabricating processes.

These and other objects and advantages of the present invention will be readily appreciable from the following description of preferred embodiments of the invention and from the accompanying drawings and claims.

### BRIEF DESCRIPTION OF THE DRAWINGS

The nature and mode of operation of the present invention will now be more fully described in the following detailed description of the invention taken with the accompanying drawing figures, in which:

FIG. 1 is a partial cross-section of a present invention stator and clutch assembly in a torque converter with an axially displaceable clutch plate and hub in an unlocked mode;

FIG. 2 is a partial cross-section of the stator and clutch assembly in FIG. 1 in a locked mode;

FIG. 3 is a partial cross-section of a present invention stator and clutch assembly in a torque converter with an integral clutch plate and hub in an unlocked mode; and,

FIG. 4 is a partial cross-section of the stator and clutch assembly in FIG. 3 in a locked mode.

### DETAILED DESCRIPTION OF THE INVENTION

At the outset, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspects.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described.

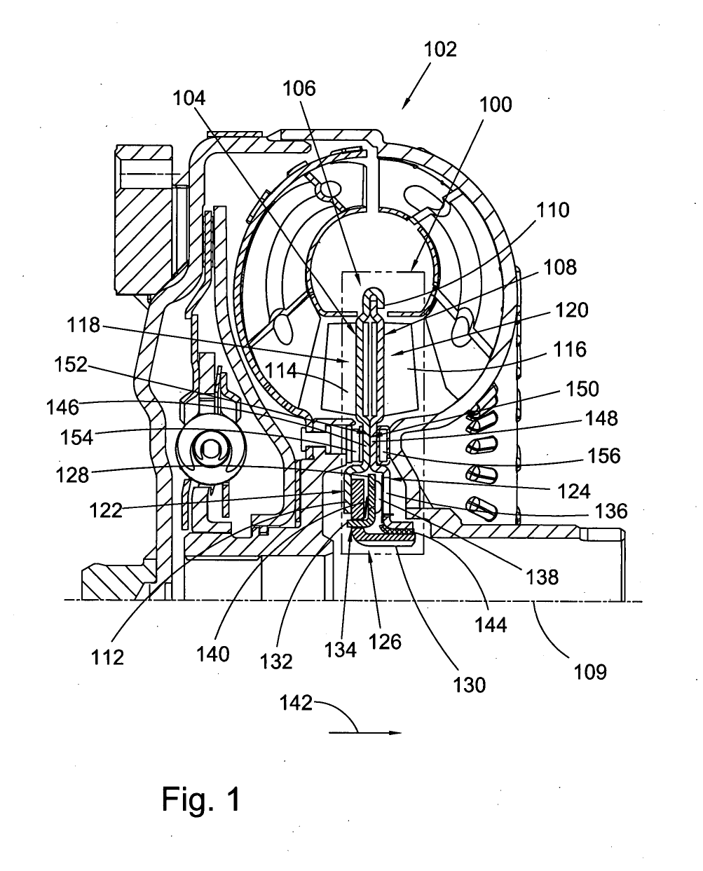

FIG. 1 is a partial cross-section of present invention stator and clutch assembly 100 in torque converter 102 with an axially displaceable clutch plate and hub in an unlocked mode.

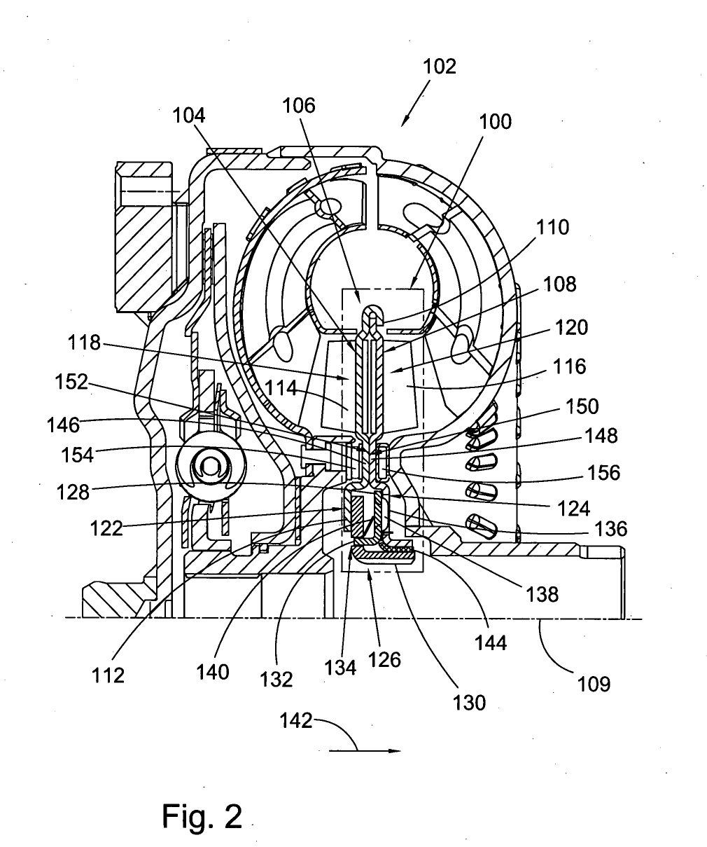

FIG. 2 is a partial cross-section of assembly 100 in a locked mode. The following should be viewed in light of FIGS. 1 and 2. Assembly 100 includes first half 104 for stator 106 and second half 108 for the stator. By halves, we mean that the structure for the stator is substantially formed by halves 104 and 108. Halves 104 and 108 also can be referred to as axial halves or axial ends. Alternately stated, halves 104 and 108 are connected along a radial plane with respect to axis 109. The first and second halves are each formed from single pieces, respectively. For example, in cross-section, half 104 is a single piece from end 110 to end 112. In some aspects, stator 106 is formed by stamping. For example, halves 104 and 108 are each formed from respective stamped metal pieces.

Blades for stator 106 can be formed by any means known in the art. In some aspects (not shown), one-part blades are used. Two-part blades are shown in the figures, for example, as described in the commonly assigned United States Provisional Patent Application titled “TWO-PART STATOR BLADE,” inventors Brees et al., filed on the same day as the present application. Blades 114 and 116 for the stator are disposed within annulus 118 and 120, respectively, of halves 104 and 108, respectively. Thus, the halves or axial ends referenced above are at least with respect to the structure to which the blades are connected.

In some aspects, inner circumferential portions 122 and 124 of halves 104 and 108, respectively, are configured to form a portion of one-way clutch 126, as described in the commonly assigned United States Provisional Patent Application titled “STATOR AND ONE-WAY CLUTCH ASSEMBLY FOR A TORQUE CONVERTER,” inventors Hemphill et al., filed the same day as the present invention. In some aspects, portions 122 and 124 are integral to halves 104 and 108, respectively, that is, for example, portion 122 and half 104 are formed from a single piece of material. In some aspects (not shown), portions 122 and 124 are separately formed from halves 104 and 108, respectively, and connected by any means known in the art. Clutch 126 includes an axially displaceable plate 128 connected to hub 130. In FIGS. 1 and 2, plate 128 is separately formed from the hub, rotationally engaged with the hub, and axially displaceable with respect to the hub. For example, segments 132 of plate 128 extend axially through openings 134 in hub 130. Segments 132 rotationally engage the hub at the edges of the opening and move axially through the opening. It should be understood that other configurations can be used to rotationally lock plate 128 and the hub while allowing the plate to move axially with respect to the hub.

Plate 128 and portions 122 or 124 are operatively arranged to form the portion, noted supra, of clutch 126. For example, in FIGS. 1 and 2, portions 122 and 124 form the axial ends of the clutch. Further, plate 128 and portion 122 or 124 are arranged to lockingly engage. In FIGS. 1 and 2, plate 128 and portion 124 are arranged to lockingly engage. By lockingly engage we mean that plate 128 and portion 122 or 124 are configured such that applicable portions of the plate and portion engage and lock when the stator is operating in the lock mode, that is, when rotational energy from the stator is to be transferred to hub 126. Further, the applicable portions are arranged so that the segment and plate rotate independently, for example, slide over each other without locking, when the stator is operating in the free wheel mode, that is, when the stator and the hub are to be rotationally disconnected.

In some aspects, portion 124 includes at least one opening 136 and plate 128 includes at least one protrusion 138 axially aligned with openings 136. By axially aligned, we mean that the openings and protrusions are aligned parallel to axis 109. Any means known in the art can be used to form openings 136 and protrusions 138. In addition, in some aspects, a ramp and slot arrangement as described in the commonly assigned U.S. Provisional Patent Application No. 60/710,828, titled “STATOR HAVING AN AXIALLY ENGAGING AND DISENGAGING ONE-WAY CLUTCH MECHANISM FOR A TORQUE CONVERTER,” inventors Brees et al., filed Aug. 24, 2005, can be used. In some aspects (not shown), portion 124 includes indentations rather than openings aligned with the protrusions. That is, portion 124 remains continuous (no openings) in the clutch. The protrusions can be ramp-like and the indentations can be substantially notch-shaped. The protrusions and indentations are complimentarily configured so that the protrusions and indentations snuggly engage when portion 124 rotates in the locked mode.

In some aspects (not shown), the configuration described supra is reversed. That is, plate 128 includes at least one opening and portion 124 includes at least one protrusion radially aligned with the openings.

Assembly 100 also includes a displacement element arranged to urge plate 128 axially toward whichever of portions 122 or 124 the plate is arranged to engage. In FIGS. 1 and 2, element 140 is disposed between hub 130 and plate 128 and applies force on the plate in axial direction 142, that is, toward portion 124. Element 140 can be any displacement element known in the art, including, but not limited to a diaphragm spring or a spring shaped as fingers in the circumferential direction.

In some aspects, assembly 100 includes wear-prevention element 144 disposed between portion 124 and the hub. Element 144 can be any wear-prevention element known in the art, including, but not limited to a bushing. In some aspects (not shown), portion 124 is in direct contact with hub 130. Typically, portion 124 is softer than the hub, facilitating this direct contact. In some aspects (not shown), the configuration of plate 128 and portions 122 and 124 is reversed. For example, portion 122 is arranged to engage plate 128. Then, a wear-prevention element can be disposed between portion 122 and the hub or portion 122 and the hub can be in direct contact.

In some aspects, halves 104 and 108 include annular portions 146 and 148, respectively, disposed between clutch 126 and annulus 118 and 120, respectively. At least parts of portions 146 and 148 are in axial contact, that is, in contact in a line parallel to axis 109. For example, surface 150 of portion 146 and surface 152 of portion 148 are in contact. In some aspects, portions 146 and 148 are operatively arranged to receive non-encapsulated bearing 154 and encapsulated bearing 156, respectively. The assembly is not limited to any particular combination of encapsulated or non-encapsulated bearings. It also should be understood that any other means known in the art, including, but not limited to thrust washers and bushings can be used in place of the bearings. In some aspects, halves 104 and 108 include retention elements (not shown), such as clips, to hold the bearings. Since portions 146 and 148 are solid pieces in contact, these portions do not need stiffening to support the bearings and maintain the bearings in the proper configuration. Alternately stated, a load can transfer directly through portions 146 and 148.

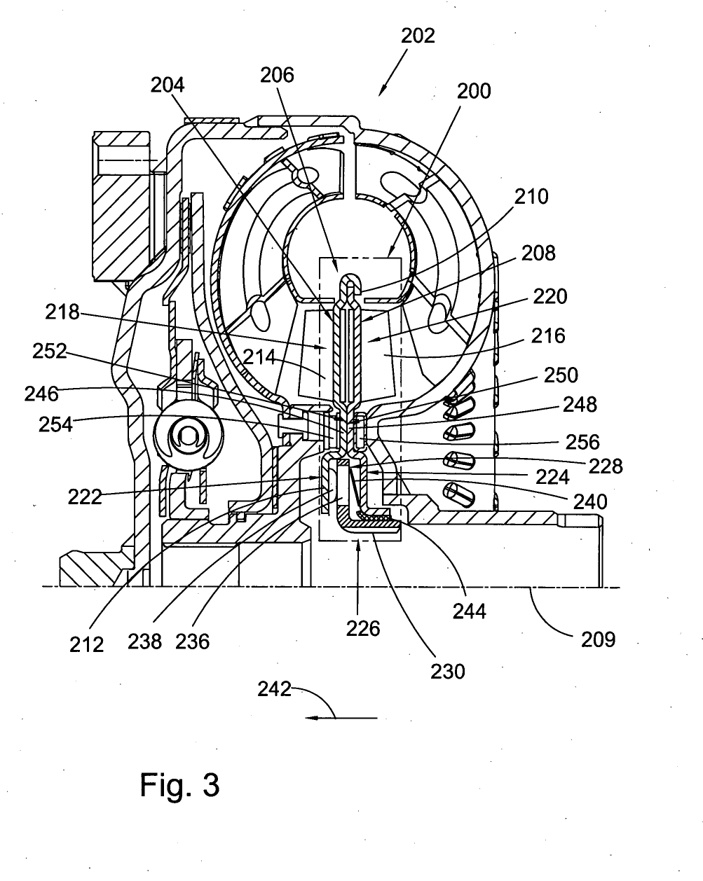

FIG. 3 is a partial cross-section of present invention stator and clutch assembly 200 in torque converter 202 with an integral clutch plate and hub in an unlocked mode.

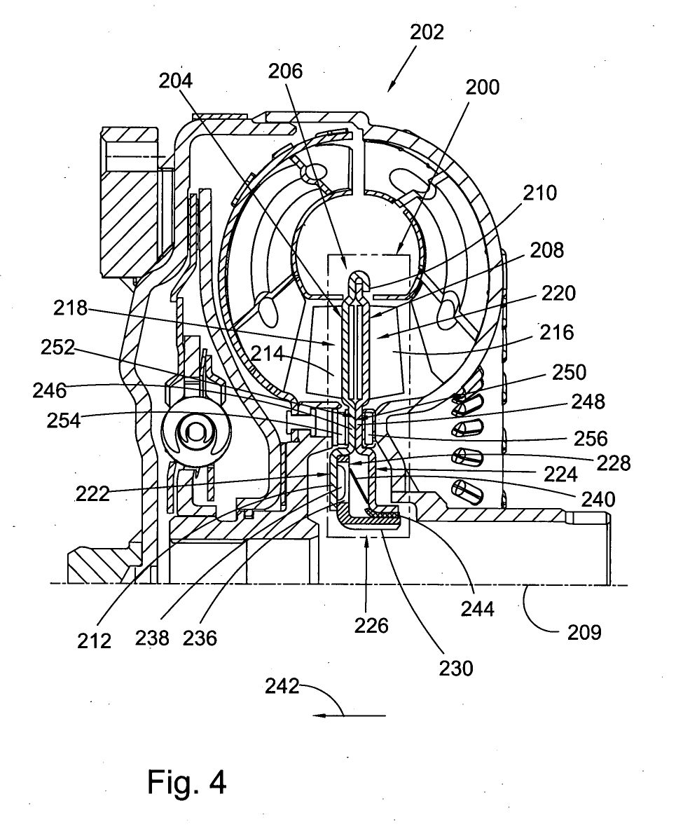

FIG. 4 is a partial cross-section of assembly 200 in a locked mode. The following should be viewed in light of FIGS. 3 and 4. Assembly 200 includes first half 204 for stator 206 and second half 208 for the stator. In general, the discussion regarding halves 104 and 108 and stator 106 is applicable to assembly 200. By halves, we mean that the structure for the stator is substantially formed by halves 204 and 208. Halves 204 and 208 also can be referred to as axial halves or axial ends. Alternately stated, halves 204 and 208 are connected along a radial plane with respect to axis 209. The first and second halves are each formed from single pieces, respectively. For example, in cross-section, half 204 is a single piece from end 210 to end 212. In some aspects, stator 206 is formed by stamping. For example, halves 204 and 208 are each formed from respective stamped metal pieces.

Blades 214 and 216 for the stator are disposed within annulus 218 and 220, respectively, of halves 204 and 208, respectively. The discussion regarding blades 114 and 116 in the descriptions of FIGS. 1 and 2 is applicable to FIGS. 3 and 4, and in the interest of brevity is not repeated here.

In some aspects, inner circumferential portions 222 and 224 of halves 204 and 208, respectively, are configured to form a portion of one-way clutch 226, as described in the commonly assigned United States Provisional Patent Application titled “STATOR AND ONE-WAY CLUTCH ASSEMBLY FOR A TORQUE CONVERTER,” inventors Hemphill et al., filed the same day as the present invention. In some aspects, portions 222 and 224 are integral to halves 204 and 208, respectively, that is, for example, portion 222 and half 204 are formed from a single piece of material. In some aspects (not shown), portions 222 and 224 are separately formed from halves 204 and 208, respectively, and connected by any means known in the art. Clutch 226 includes an axially displaceable plate 228 connected to hub 230. In FIGS. 3 and 4, plate 228 is integral with the hub. That is, plate 228 and hub 226 are formed from a same piece of material. In the aspects shown in FIGS. 3 and 4, hub 226 is axially displaceable. Hereinafter, plate 228 and hub 226 will be used interchangeably.

Plate 228 and portions 222 or 224 are operatively arranged to form the portion, noted supra, of clutch 226. For example, in FIGS. 3 and 4, portions 222 and 224 form the axial ends of the clutch. Further, plate 228 and portion 222 or 224 are arranged to lockingly engage. In FIGS. 3 and 4, plate 228 and portion 222 are arranged to lockingly engage. By lockingly engage we mean that plate 228 and portion 222 or 224 are configured such that applicable portions of the plate and portion engage and lock when the stator is operating in the lock mode, that is, when rotational energy from the stator is to be transferred to hub 226. Further, the applicable portions are arranged so that the segment and plate rotate independently, for example, slide over each other, without locking when the stator is operating in the free wheel mode, that is, when the stator and the hub are to be rotationally disconnected.

In some aspects, plate 228 includes at least one opening 236 and portion 222 includes at least one protrusion 238 axially aligned with openings 236. Any means known in the art can be used to form openings 236 and protrusions 238. In addition, in some aspects, a ramp and slot arrangement as described in the commonly assigned U.S. Provisional Patent Application No. 60/710,828, titled “STATOR HAVING AN AXIALLY ENGAGING AND DISENGAGING ONE-WAY CLUTCH MECHANISM FOR A TORQUE CONVERTER,” inventors Brees et al., filed Aug. 24, 2005, can be used. The discussion in FIGS. 1 and 2 regarding protrusions and openings for plate 128 and portion 124 is applicable to plate 228 and portions 222.

In some aspects (not shown), the configuration described supra is reversed. That is, portion 222 includes at least one opening and plate 228 includes at least one protrusion radially aligned with the openings.

Assembly 200 also includes a displacement element arranged to urge plate 228 axially toward whichever of portions 222 or 224 the plate is arranged to engage. In FIGS. 3 and 4, element 240 is disposed between portion 224 and plate 228 and applies force on the plate in axial direction 242, that is, toward portion 222. Element 240 can be any displacement element known in the art, including, but not limited to a diaphragm spring or a spring shaped as fingers in the circumferential direction.

In some aspects, assembly 200 includes wear-prevention element 244 disposed between portion 224 and the hub. Element 244 can be any wear-prevention element known in the art, including, but not limited to a bushing. In some aspects (not shown), portion 224 is in direct contact with hub 230. Typically, portion 224 is softer than the hub, facilitating this direct contact. In some aspects (not shown), the configuration of plate 228 and portions 222 and 224 is reversed. For example, portion 224 is arranged to engage plate 228. Then, a wear-prevention element can be disposed between portion 222 and the hub or portion 222 and the hub can be in direct contact.

In some aspects, halves 204 and 208 include annular portions 246 and 248, respectively, disposed between clutch 226 and annulus 218 and 220, respectively. At least parts of portions 246 and 248 are in axial contact. For example, surface 250 of portion 246 and surface 252 of portion 248 are in contact. In some aspects, portions 246 and 248 are operatively arranged to receive non-encapsulated bearing 254 and encapsulated bearing 256, respectively. The assembly is not limited to any particular combination of encapsulated or non-encapsulated bearings. It also should be understood that any other means known in the art, including, but not limited to thrust washers and bushings can be used in place of the bearings. In some aspects, halves 204 and 208 include retention elements (not shown), such as clips, to hold the bearings. Since portions 246 and 248 are solid pieces in contact, these portions do not need stiffening to support the bearings and maintain the bearings in the proper configuration. Alternately stated, a load can transfer directly through portions 246 and 248.

Returning to FIGS. 1 and 2, advantageously, halves 104 and 108 form part of clutch 126, as described supra. For example, portion 124 forms part of the stator and the clutch, in particular, an axial end and a part of the locking or engaging mechanism for the clutch. Portion 122 forms the other axial end. That is, clutch 126 is at least partially axially bracketed by portions 122 and 124. Thus, stator 106 and clutch 126 can be manufactured or assembled together, reducing the parts count and complexity. For example, assembly 100 can be stacked in torque converter 102. Also, assembly 100 forms a “self-contained” unit. That is, once the components of clutch 126 are positioned between portions 122 and 124, the portions hold the components in place and assembly 100 can be stacked as a unit. For example, the assembly could be assembled in one location and then transported elsewhere for stacking in a torque converter. It should be understood that assembly 100 is not limited to the configurations shown in the figures. For example, other sizes, shapes, combinations, configurations, and orientations of component parts of the assembly are included within the spirit and scope of the invention as claimed. Returning to FIGS. 3 and 4, the preceding discussion is applicable assembly 200 and torque converter 202.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

What we claim is:

1. A stator and clutch assembly for a torque converter, comprising:
a first half for a stator; and,
a second half for said stator, wherein said first and second halves are each formed from first and second single pieces, respectively, and wherein blades for said stator are disposed within respective annuli for said first and second halves.

2. The assembly recited in claim 1 further comprising: a one-way clutch; and, wherein said first and second halves further comprise first and second inner circumferential portions, respectively, configured to form a portion of said one-way clutch.

3. The assembly recited in claim 2 further comprising: an axially displaceable plate connected to a hub; and, wherein said plate and said first inner circumferential portion are operatively arranged to form a portion of said one-way clutch.

4. The assembly recited in claim 3 wherein said plate and said first inner circumferential portion are arranged to lockingly engage.

5. The assembly recited in claim 3 wherein said first inner circumferential portion further comprises at least one opening and said plate further comprises at least one protrusion axially aligned with said at least one opening.

6. The assembly recited in claim 3 wherein said plate further comprises at least one opening and said first inner circumferential portion further comprises at least one protrusion axially aligned with said at least one opening.

7. The assembly recited in claim 3 further comprising: a first displacement element arranged to urge said plate axially toward said first inner circumferential portion.

8. The assembly recited in claim 3 wherein said plate and said hub are formed from a third single piece.

9. The assembly recited in claim 8 further comprising: a second displacement element disposed between said second inner circumferential portion and said plate.

10. The assembly recited in claim 3 wherein said plate is axially displaceable with respect to said hub.

11. The assembly recited in claim 10 further comprising: a third displacement element disposed between said plate and said hub.

12. The assembly recited in claim 1 further comprising: a first wear-prevention element disposed between said hub and a first element selected from the group consisting of said first and second inner circumferential portions.

13. The assembly recited in claim 1 wherein said first half further comprises a first annular portion disposed between said clutch and said annulus for said first half, said second half further comprises a second annular portion disposed between said clutch and said annulus for said second half, and at least portions of said first and second annular portions are in contact.

14. The assembly recited in claim 13 wherein said torque converter further comprises first and second bearings; and, wherein said first and second annular portions are operatively arranged to receive said first and second bearings, respectively.

15. The assembly recited in claim 14 wherein said first and second halves further comprise at least one first and second retention elements, respectively, operatively arranged to engage said first and second bearings, respectively.

16. A stator and clutch assembly for a torque converter, comprising:
a first axial portion for a stator;
a second axial portion for said stator; and,
a one-way clutch, wherein, said first axial portion further comprises a first annular portion disposed radially outside said clutch, said second axial portion further comprises a second annular portion disposed radially outside said clutch, at least portions of said first and second annular portions are in axial contact, and said first and second annular portions are operatively arranged to receive first and second bearings, respectively.

17. A stator and clutch assembly for a torque converter, comprising:
a first axial end for a stator comprising a first circumferential portion disposed between blades for said stator and an axis for said stator;
a second axial end for said stator comprising a second circumferential portion disposed between said blades and said axis; and,
a one-way clutch comprising an axially displaceable plate, wherein said first and second ends are each formed from first and second single pieces, respectively, wherein said plate and said first circumferential portion are operatively arranged to form a portion of said one-way clutch, and wherein said plate and said first circumferential portion are arranged to lockingly engage.
